(19) United States
(12) Patent Application Publication
(10) Pub. No.: US 2003/0046071 A1
(43) Pub. Date: Mar. 6, 2003

(54) Voice recognition apparatus and method

(75) Inventor: Blair Wyman, Rochester, MN (US)

Correspondence Address: MARTIN & ASSOCIATES, LLC, P O BOX 548, CARTHAGE, MO, 64836-0548, US

(73) Assignee: International Business Machines Corporation, Armonk, NY

(21) Appl. No.: 09/947,987

(22) Filed: Sep. 6, 2001

(51) Int. Cl. G10L 15/26

(52) U.S. Cl. 704/235

(57) ABSTRACT

A voice recognition apparatus and method processes a voice audio stream. As sounds in the voice audio stream are identified that correspond to defined words, the voice recognition system writes the text for the words to an output file. If a sound is encountered that is not recognized as a defined word, a visual marker is placed in the output file to mark the location, and a corresponding audio clip is generated and correlated to the visual marker. When the output file is displayed, any sounds not recognized as defined words are represented by an icon that represents an audio clip. If the user cannot determine from the context what the missing word or phrase is, the user may click on the audio icon, which causes the stored audio clip to be played. In this manner a user can dictate into a voice recognition system with complete confidence that any unrecognized words or phrases will be preserved in their original audio format so the user can later listen and enter the missing information into the document. In a second embodiment, the voice recognition apparatus processes digital audio information and reduces the size of the digital audio information by replacing portions of the digital audio information with corresponding text, while leaving any portion that does not correspond to a defined word.

### BACKGROUND OF THE INVENTION

1. Technical Field

This invention generally relates to computer systems, and more specifically relates to voice recognition in computer systems.

2. Background Art

Since the dawn of the computer age, computer systems have evolved into extremely sophisticated devices, and computer systems may be found in many different settings. One relatively recent advancement is voice recognition by computers. Voice recognition has been portrayed in a variety of science fiction television shows and movies, where a user simply talks to a computer to accomplish certain tasks. One common task that could be automated using voice recognition is the generation of a text document using a word processor.

Several voice recognition systems exist that allow a user to enter text into a word processor by speaking into a microphone. Dragon Naturally Speaking is one known software package that provides voice recognition capability with popular word processors. When known voice recognition systems encounter a sound that does not correlate to a defined word or phrase, a visual indication is placed in the text document to indicate that something was not understood by the voice recognition system. The user must then go through the text file carefully, looking for visual indications of an incomplete transcription, and must try to remember the missing word(s) or guess the missing word(s) based on the surrounding context. The visual indication is then replaced with the appropriate text. In this manner an incomplete transcription of a speaker's words can be corrected until the transcription is complete and correct.

In the prior art, the speaker must visually scan the displayed text file for indications of an incomplete transcription, and try to figure out what's missing. This process greatly inhibits the efficiency of generating documents using voice recognition. Without a voice recognition system that gives confidence to the speaker that no information will be lost, the usefulness of voice recognition systems will continue to be limited.

### DISCLOSURE OF INVENTION

According to the preferred embodiments, a voice recognition apparatus and method processes a voice audio stream. As sounds in the voice audio stream are identified that correspond to defined words, the voice recognition system writes the text for the words to an output file. If a sound is encountered that is not recognized as a defined word, a visual marker is placed in the output file to mark the location, and a corresponding audio clip is generated and correlated to the visual marker. When the output file is displayed, any sounds not recognized as defined words are represented by an icon that represents an audio clip. If the user cannot determine from the context what the missing word or phrase is, the user may click on the audio icon, which causes the stored audio clip to be played. In this manner a user can dictate into a voice recognition system with complete confidence that any unrecognized words or phrases will be preserved in their original audio format so the user can later listen and enter the missing information into the document. In a second embodiment, the voice recognition apparatus processes digital audio information and reduces the size of the digital audio information by replacing portions of the digital audio information with corresponding text, while leaving alone any portion that does not correspond to a defined word.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a prior art voice recognition system;

FIG. 2 is a block diagram showing sample dictated text;

FIG. 3 is a block diagram of a prior art wordprocessor that displays the output text file 140 generated by the voice recognition processor 120 in FIG. 1 for the dictated text in FIG. 2;

FIG. 4 is a prior art voice recognition method for generating a corresponding text file from a voice audio stream;

FIG. 5 is a block diagram of a voice recognition system in accordance with the preferred embodiments;

FIG. 6 is a block diagram of a wordprocessor in accordance with the preferred embodiments that displays the output file 540 generated by the voice recognition processor 520 in FIG. 5;

FIG. 7 is a voice recognition method in accordance with the preferred embodiments;

FIG. 8 is a block diagram of an apparatus in accordance with the preferred embodiments;

FIG. 9 is a sample menu that allows a user to configure audio preferences for the voice recognition processor of FIG. 5; and

FIG. 10 is block diagram showing a clarity meter that indicates the degree to which sounds in an incoming voice audio stream are being converted to text.

### BEST MODE FOR CARRYING OUT THE INVENTION

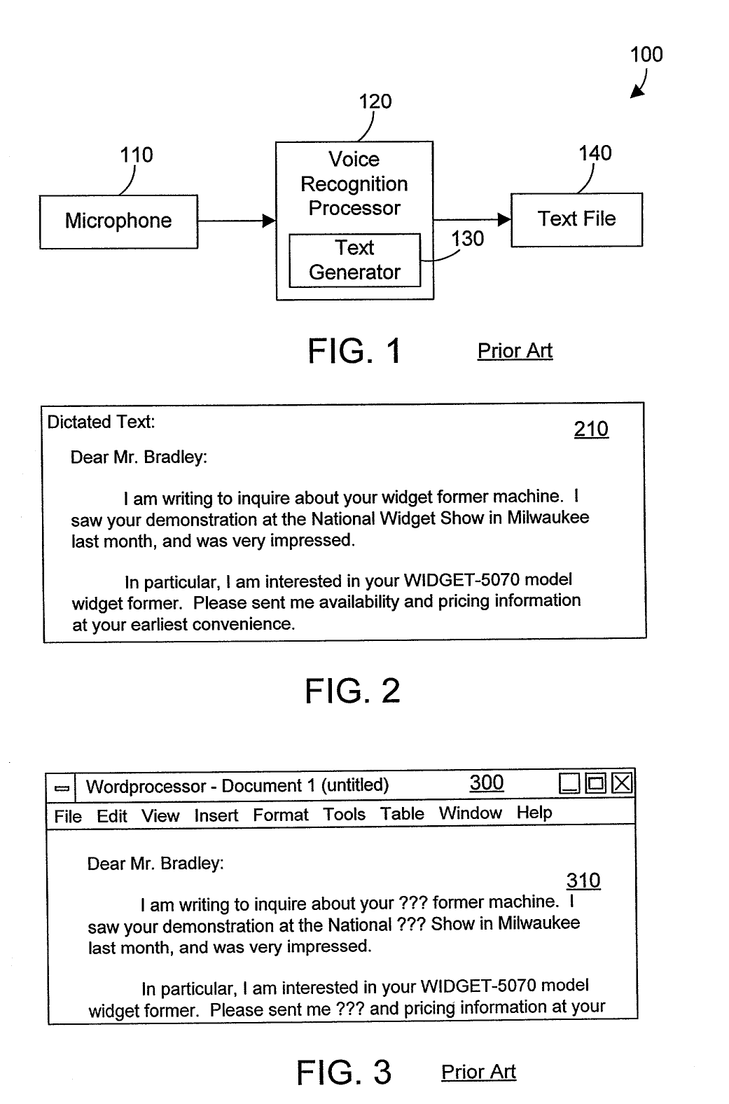

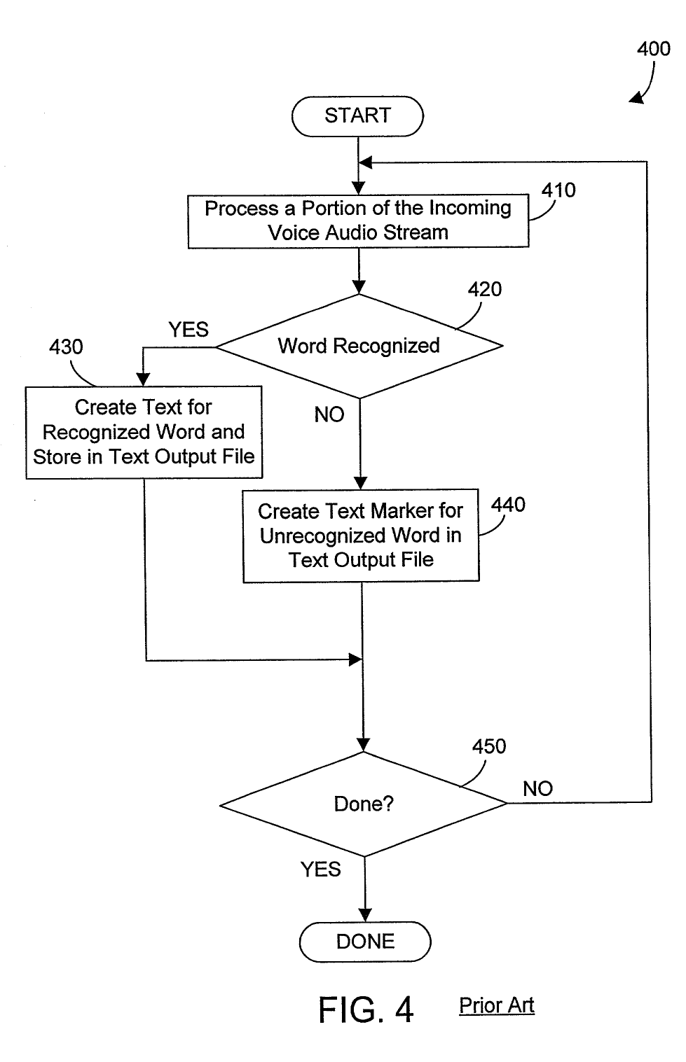

The preferred embodiments relate to voice recognition apparatus and methods. To understand the preferred embodiments, examples of a prior art apparatus and method are first presented in FIGS. 1-4.

One example of a prior art voice recognition system is shown in FIG. 1. A user speaks into a microphone 110. The resulting audio stream from the microphone 110 is processed real-time by a voice recognition processor 120, which compares portions of the audio stream to a dictionary of known words and a sample of the speaker's voice patterns for certain words or phrases. When the voice recognition processor 120 recognizes a word, it uses a text generator 130 to output the corresponding text to the text file 140, which is typically displayed using a word processor.

When the voice recognition processor 120 recognizes all the words that the user speaks into microphone, the text file is a perfect representation of the words the user spoke. Note, however, that a perfect match between the spoken text and the resulting text file is almost never achieved due to variations in the speaker's inflection, tone of voice, speed of speaking, and other limitations in the ability to recognize words in a voice audio stream. The real problem that arises is how to deal with sounds that are not recognized as text.

In the prior art, if a sound is not recognized as text, a text marker is placed in the text file to mark where the voice recognition processor had difficulty interpreting the audio speech of the speaker. One example is shown in FIGS. 2 and 3, where the dictated text is shown in window 210 of FIG. 2, and the corresponding text file that was generated by the voice recognition processor 120 is shown in window 310 of FIG. 3.

A prior art method 400 for processing a voice audio stream begins by processing portions of the incoming voice audio stream real-time as they are received (step 410). If a word is recognized in the voice audio stream (step 420=YES), text for the recognized word is stored in the text output file (step 430). If the sound is not recognized as a word or group of words (step 420=NO), a text marker is created in the text output file to identify where a sound was not recognized as a word (step 440). This process continues (step 450=NO) until the processing of the incoming audio stream is complete (step 450=YES).

We assume for the example in FIGS. 2 and 3 that the voice recognition processor 120 (FIG. 1) had trouble interpreting the word widget in two locations and the word availability in one location. In window 310, we see that these words that were not recognized as defined words are replaced with a text marker comprising three questions marks ??? to indicate visually to the user that something in the audio stream was missed because the voice recognition processor did not recognize the sound in the audio stream as any defined word. In the prior art, the user must visually scan for the marks that indicate trouble with the transcription, and try to determine from the surrounding language what the missing word or words may be. This may be relatively easy if there are few misses and if the transcription is reviewed immediately after it is generated by the same person who spoke the words. However, if there are many misses, if a day or more passes between speaking and reviewing the transcription, or if a person other than the speaker (such as a secretary) is reviewing the transcription, determining what the missing language is may be very difficult, indeed. For this reason, the usefulness of known voice recognition systems has been limited. The alternative in the prior art is for the speaker to watch the transcription as it is taking place, and stop immediately to correct any omissions when they occur. This, of course, breaks up the work flow and concentration of the speaker, and may cause frustration in using prior art voice recognition systems.

The preferred embodiments provide an apparatus and method that overcomes the limitations of the prior art by maintaining a digital recording of any audio clips that do not correlate to defined words. These audio clips are represented in the output file by icons that, when clicked, cause the original audio clip to be played. This allows a user to use the apparatus of the preferred embodiments at high speed with complete confidence that no information will be lost, because any information that cannot be converted to text is marked in the output file and retained in its original audio format. In addition, the apparatus and method of the preferred embodiments may be used to compress the size of a digital audio file by replacing recognized words with text, while leaving unrecognized sounds as digital audio clips.

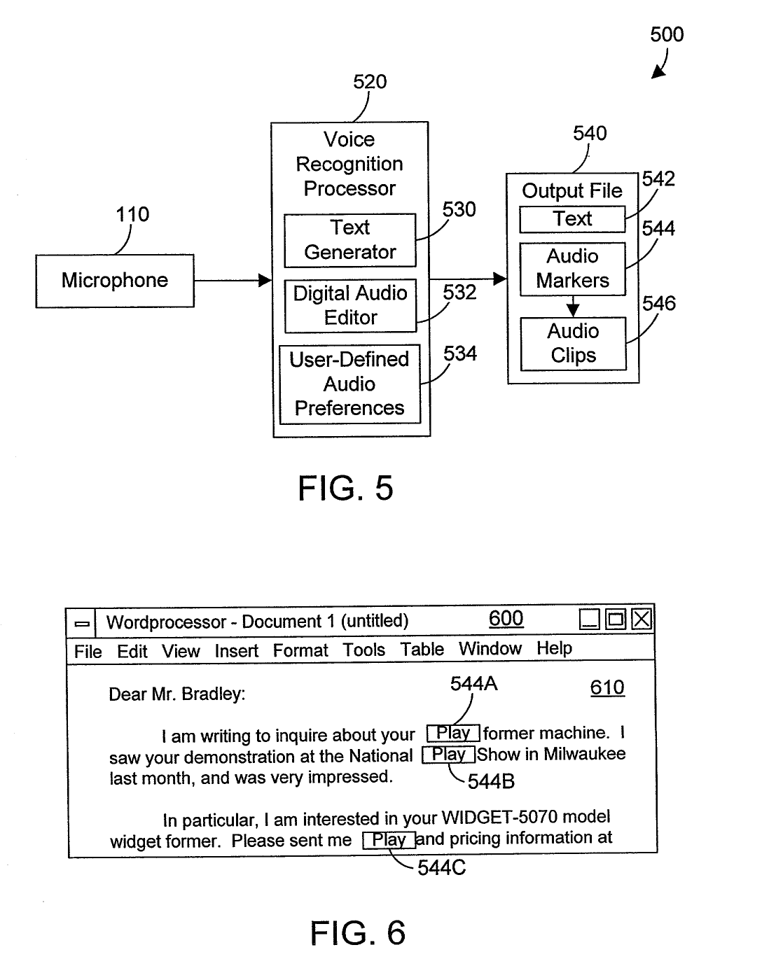

Referring to FIG. 5, a voice recognition system 500 includes a microphone 1100 coupled to a voice recognition processor 520. We assume that voice recognition processor 520 processes a digital audio representation of voice audio information spoken into microphone 110, regardless of whether the conversion from analog audio to digital audio occurs within the microphone 110, within the voice recognition processor 520, or within some other device interposed between the microphone 110 and the voice recognition processor 520. The voice recognition processor 520 includes a text generator 530, a digital audio editor 532, and audio storage preferences 534. Voice recognition processor 520 processes the digital audio stream, and generates an output file 540. When voice recognition processor 520 identifies a portion of the digital audio stream that corresponds to a defined word, the text generator 530 generates text 542 for the defined word in the output file 540. If a portion of the digital audio stream has sound that does not correspond to any defined word, the digital audio editor 532 is used to create an audio clip 546 of the portion in the output file 540 according to user-defined audio preferences 534. The voice recognition processor also places an audio marker 544 in the output file that correlates the position of the audio clip 546 with respect to the text 542. In this manner, any audio information that cannot be converted to text is maintained in its digital audio representation in the output file 540 so the clips that were not converted to text can be listened to at a later time. This method assures that no information is lost as a person speaks into the voice recognition system 500.

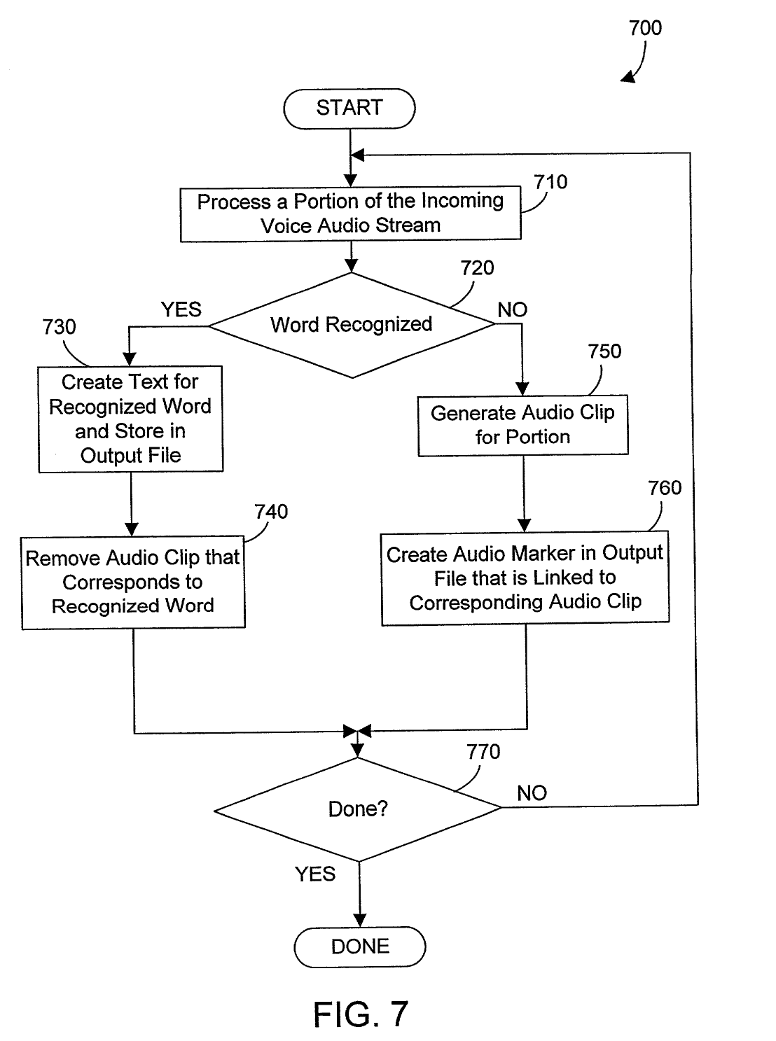

Referring to FIG. 7, a method 700 in accordance with the preferred embodiments begins by processing a portion of the incoming voice audio stream (step 710). If the processed portion corresponds to a defined word (step 720=YES), text corresponding to the defined word is created and stored in the output file (step 730). The size of the incoming voice audio stream may then be reduced by removing a portion of the incoming audio stream that corresponds to the recognized word (step 740). If a portion of the incoming audio stream is not recognized as a word (step 720=NO), an audio clip is generated for the portion (step 750). An audio marker is then inserted into the output file that links the marker to the corresponding audio clip (step 760). This process continues (step 770=NO) until all of the incoming audio stream has been processed (step 770=YES). Note that method 700 may apply to real-time processing of an incoming audio stream that is generated as a person speaks, or may also apply to the processing of an audio stream that was previously recorded. This allows method 700 to be used real-time or to be used as a post-processor for pre-recorded information.

Referring now to FIG. 6, we apply method 700 to an audio input stream that corresponds to the text shown in FIG. 2. We assume (as we did for FIG. 3) that the voice recognition processor 520 could not recognize the words “widget” in two locations and could not recognize the word “availability” in another location. As shown in FIG. 6, the output file that is displayed in window 610 includes audio markers (e.g., 544A, 544B, and 544C) that mark the location in the output file where the audio input stream could not be converted to text. These audio markers, when clicked on the by user, cause an audio clip 546 corresponding to the audio marker 544 to be played to the user. In this manner, a user can listen to the actual audio information for each clip that could not be interpreted by the voice recognition processor 520.

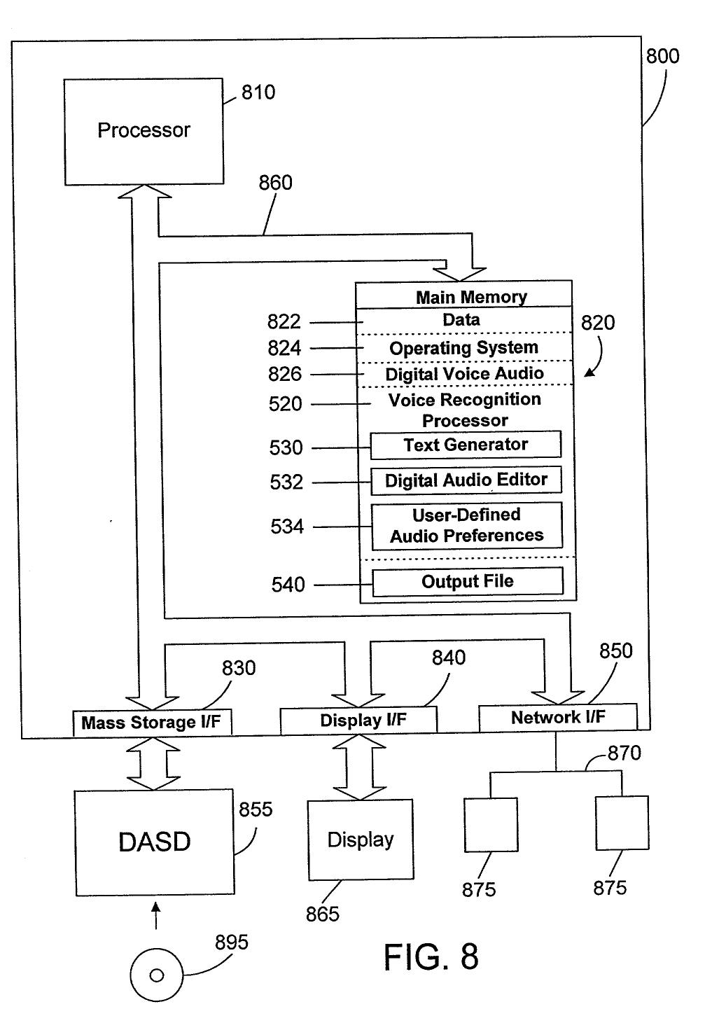

Referring now to FIG. 8, a computer system 800 is one suitable implementation of an apparatus in accordance with the preferred embodiments of the invention. Computer system 800 is an IBM iSeries computer system. However, those skilled in the art will appreciate that the mechanisms and apparatus of the present invention apply equally to any computer system, regardless of whether the computer system is a complicated multiuser computing apparatus, a single user workstation, or an embedded control system. As shown in FIG. 8, computer system 800 comprises a processor 810, a main memory 820, a mass storage interface 830, a display interface 840, and a network interface 850. These system components are interconnected through the use of a system bus 860. Mass storage interface 830 is used to connect mass storage devices (such as a direct access storage device 855) to computer system 800. One specific type of direct access storage device 855 is a readable and writable CD ROM drive, which may store data to and read data from a CD ROM 895.

Main memory 820 in accordance with the preferred embodiments contains data 822, an operating system 824, and a voice recognition processor 520 that is used to process digital voice audio information 826 and to generate therefrom a corresponding output file 540. Note that the voice recognition processor 520 and its associated components 530, 532 and 534, and the output file 540 are discussed in more detail above with reference to FIG. 5.

Computer system 800 utilizes well known virtual addressing mechanisms that allow the programs of computer system 800 to behave as if they only have access to a large, single storage entity instead of access to multiple, smaller storage entities such as main memory 820 and DASD device 855. Therefore, while data 822, operating system 824, digital voice audio 826, voice recognition processor 520, and output file 540 are shown to reside in main memory 820, those skilled in the art will recognize that these items are not necessarily all completely contained in main memory 820 at the same time. It should also be noted that the term “memory” is used herein to generically refer to the entire virtual memory of computer system 800.

Data 822 represents any data that serves as input to or output from any program in computer system 800. Operating system 824 is a multitasking operating system known in the industry as OS/400; however, those skilled in the art will appreciate that the spirit and scope of the present invention is not limited to any one operating system. Digital voice audio 826 represents any digital voice audio stream, whether it is received and processed real-time or recorded at an earlier time.

Processor 810 may be constructed from one or more microprocessors and/or integrated circuits. Processor 810 executes program instructions stored in main memory 820. Main memory 820 stores programs and data that processor 810 may access. When computer system 800 starts up, processor 810 initially executes the program instructions that make up operating system 824. Operating system 824 is a sophisticated program that manages the resources of computer system 800. Some of these resources are processor 810, main memory 820, mass storage interface 830, display interface 840, network interface 850, and system bus 860.

Although computer system 800 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 810. However, those skilled in the art will appreciate that the present invention applies equally to computer systems that simply use 1/0 adapters to perform similar functions.

Display interface 840 is used to directly connect one or more displays 865 to computer system 800. These displays 865, which may be non-intelligent (i.e., dumb) terminals or fully programmable workstations, are used to allow system administrators and users to communicate with computer system 800. Note, however, that while display interface 840 is provided to support communication with one or more displays 865, computer system 800 does not necessarily require a display 865, because all needed interaction with users and other processes may occur via network interface 850.

Network interface 850 is used to connect other computer systems and/or workstations (e.g., 875 in FIG. 8) to computer system 800 across a network 870. The present invention applies equally no matter how computer system 800 may be connected to other computer systems and/or workstations, regardless of whether the network connection 870 is made using present-day analog and/or digital techniques or via some networking mechanism of the future. In addition, many different network protocols can be used to implement a network. These protocols are specialized computer programs that allow computers to communicate across network 870. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM (e.g, 895 of FIG. 8), and transmission type media such as digital and analog communications links.

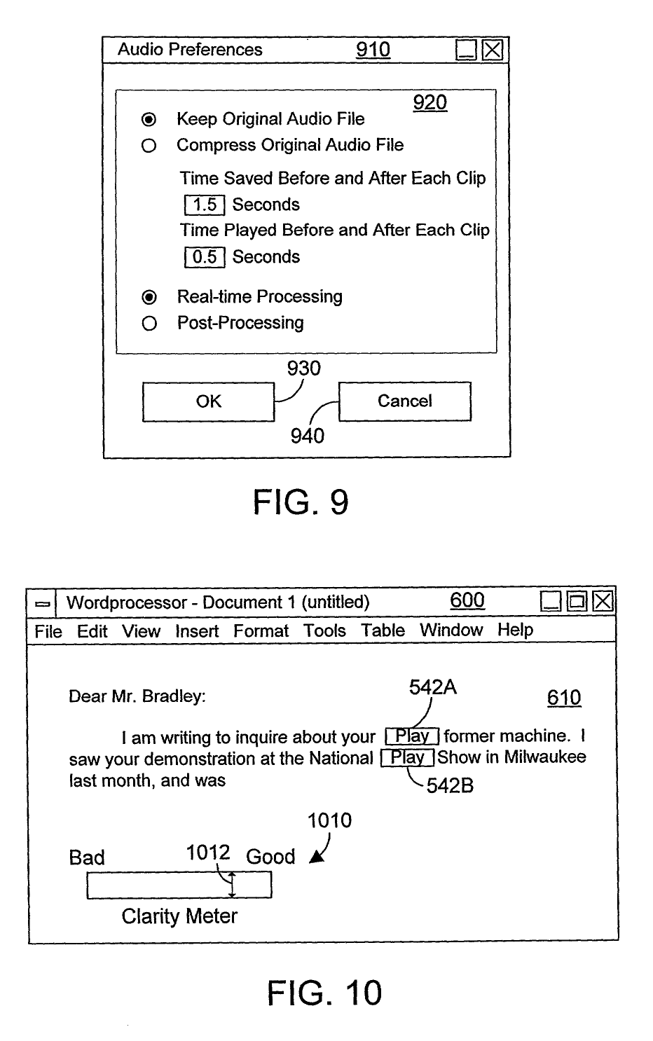

In the preferred embodiments, the user may setup audio preferences (534 in FIG. 5) that control how audio information is recorded in clips and presented to the user. Referring to FIG. 9, an audio preferences menu 910 includes a window 920 that is displayed to a user. We assume that the audio preferences menu 910 may be invoked in any suitable manner, such as a user clicking on the “Edit” menu item, then selecting an “Audio Preferences” selection in the Edit drop-down menu. Another way to invoke the audio preferences menu is to right-click on an audio marker 544 and select an “Audio Preferences” selection in a menu. For the specific example shown in FIG. 9, the audio preferences determine how the audio information is recorded and/or presented to the user. The first two items in window 920 allow the user to select whether to keep the original audio file intact, or to compress the original audio file. If “Keep Original Audio File” is selected, as it is in FIG. 9, this means that the output file 540 will be generated separately from the original audio file, thereby allowing the user to review the original audio file if needed. If the “Compress Original Audio File” is selected, either the original audio file is dynamically compressed by replacing recognized word portions with corresponding text, or a separate output file 540 is generated, and after the output file 540 is complete, the original audio file is deleted. In either case, the result is an output file 540 that contains a combination of text, audio markers, and corresponding audio clips, while the original audio file no longer exists.

Another audio preference the user may select is the amount of time stored before and after each clip, and the time played before and after each clip. The audio clips 546 are the audio portions that contained sounds that could not be recognized as defined words. For the selections in FIG. 9, a user has selected to store 1.5 seconds before and after the clip, and to play 0.5 seconds before and after the clip. This allows the user some time to determine the context of the clip as it plays. The preferred embodiments further allow the user to dynamically change the time played before and after each clip by right-clicking on an audio marker, and selecting from the menu either “Audio Preferences” or “Change Clip Play Time”. Note that the time played before and after each clip cannot exceed the time saved before and after each clip, because only the audio information that is saved may be played. A user can thus tune the performance of the voice recognition system of the preferred embodiments by trading off the amount of stored audio information with the size of the output file.

Another audio preference the user may select is whether the voice recognition system is to operate real-time (as an audio stream is received), or in a post-processing mode that processes a previously-recorded digital audio file. If real-time processing is selected (as it is in FIG. 9), the voice recognition system awaits real-time audio input from a microphone. If post-processing is selected, the voice recognition system may operate on a designated audio file or other stored audio source. Once the user has completed selecting the audio preferences, the user may click on the OK button 930, or may click on the cancel button 940 to exit the audio preferences menu 910 without saving changes.

Another advantage of the preferred embodiments is the ability to determine the efficiency of the voice recognition processor by analyzing what percent of the incoming audio stream is being converted to text. If the output file 540 contains a large amount of text and only a few audio markers 544 and corresponding clips 546, the voice recognition system has been relatively successful at converting audio voice information to text. If the output file 540 contains many audio markers 544 and corresponding clips 546, the voice recognition system is having difficulty interpreting sounds in the input audio stream as words. One of the main factors that determines the efficiency of the conversion from audio to text is how clearly the speaker enunciates the words he or she is speaking. For this reason, the efficiency of the conversion from audio to text may be displayed to a user in the form of a “clarity meter”. Referring to FIG. 10, one specific embodiment of a clarity meter 1010 is a bar meter with Bad on one extreme and Good on the other, and an indicator 1012 that shows how efficiently the voice recognition processor is converting the audio information to text. One suitable way for displaying the clarity meter 1010 is to keep track of the size of the audio portions that are converted to text, the size of the audio portions stored in clips, and have the clarity meter indicate on a percentage scale the percent of time the audio is successfully converted to text.

Clarity meter 1010 provides real-time feedback to a user to indicate the performance of the voice recognition processor of the preferred embodiments. If the performance drops, the clarity meter will so indicate, and the user can then take remedial measures such as talking more clearly, more slowly, or more loudly. In addition, clarity meter 1010 may also be used to analyze the clarity of previously-recorded audio information in a post-processing environment.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention. For example, in the preferred embodiments discussed herein, only audio that is not recognized as a defined word is stored as an audio clip. Note, however, that the voice recognition processor of the preferred embodiments determines when an audio portion matches a word with varying levels of confidence. One variation within the scope of the preferred embodiments is to specify a confidence level that must be met for the audio portion to be converted to text. If the voice recognition processor recognizes an audio portion as a word, but this recognition does not meet the specified confidence level, the text may be displayed in a highlighted form that also acts as an audio marker. In this manner, the voice recognition system may take its best guess at a word, and still store the corresponding audio clip so the user may later see whether the guess is correct or not. This an other variations are within the scope of the preferred embodiments.

What is claimed is:

1. An apparatus comprising:
at least one processor;
a memory coupled to the at least one processor; and
a voice recognition processor executed by the at least one processor, the voice recognition processor processing a voice audio stream looking for a plurality of defined words and generating an output file that includes text corresponding to the plurality of defined words, the output file further including at least one audio marker that is linked to at least one portion of the voice audio stream that does not correspond to the plurality of defined words.

2. The apparatus of claim 1 wherein the voice recognition processor, when a defined word is found in the voice audio stream, replaces in the output file the defined word in the voice audio stream with text corresponding to the defined word.

3. The apparatus of claim 1 wherein the voice recognition processor generates an audio clip for at least one portion of the voice audio stream that contains sounds that do not correlate to any defined word, and wherein each audio marker in the output file is linked to a corresponding audio clip.

4. The apparatus of claim 3 wherein the voice recognition processor determines how much of the voice audio stream is included in each audio clip according to user-defined preferences.

5. The apparatus of claim 3 wherein the voice recognition processor plays an audio clip when the corresponding audio marker is selected by a user.

6. The apparatus of claim 5 wherein the voice recognition processor determines how much of the corresponding audio clip is played according to user-defined preferences.

7. The apparatus of claim 1 wherein the voice audio stream comprises digital audio information.

8. The apparatus of claim 1 wherein the voice recognition processor displays a clarity meter that visually indicates to a user the efficiency of the voice recognition processor in converting the voice audio stream to text.

9. An apparatus comprising:
at least one processor;
a memory coupled to the at least one processor;
a voice recognition processor executed by the at least one processor, the voice recognition processor comprising:
a plurality of defined words;
a digital audio processor that processes a voice audio stream looking for the plurality of defined words;
a text generator that generates text in an output file for portions of the voice audio stream that correspond to any of the plurality of defined words; and
a digital audio editor that creates an audio clip from the voice audio stream for each portion of the voice audio stream that does not correspond to any of the plurality of defined words, wherein the digital audio editor creates an audio marker that is placed in the output file at a position that identifies the position of each audio clip relative to text generated by the text generator.

10. The apparatus of claim 9 wherein the voice recognition processor plays an audio clip when the corresponding audio marker is selected by a user during the display of the output file to a user.

11. The apparatus of claim 9 wherein the voice recognition processor displays a clarity meter that visually indicates to a user the efficiency of the voice recognition processor in converting the voice audio stream to text.

12. An apparatus comprising:
at least one processor;
a memory coupled to the at least one processor;
digital audio information residing in the memory that corresponds to a voice audio stream;
a voice recognition processor executed by the at least one processor, the voice recognition processor comprising:
a plurality of defined words;
a digital audio processor that processes the digital audio information looking for the plurality of defined words;
a digital audio compressor that reduces the size of the digital audio information by replacing at least one portion of the digital audio information with text corresponding to at least one of the plurality of defined words.

13. A method for processing a voice audio stream comprising:
processing the voice audio stream looking for a plurality of defined words;
generating an output file that includes text corresponding to the plurality of defined words and that includes at least one audio marker that is linked to a portion of the voice audio stream for each portion of the voice audio stream that does not correspond to the plurality of defined words.

14. The method of claim 13 further comprising:
when one of the plurality of defined words is found in the voice audio stream, replacing in the output file the portion of the voice audio stream that corresponds with the defined word with text corresponding to the defined word.

15. The method of claim 13 further comprising:
generating an audio clip for at least one portion of the voice audio stream that contains sounds that do not correlate to any defined word; and
linking each audio marker in the output file to a corresponding audio clip.

16. The method of claim 15 further comprising:
determining how much of the voice audio stream to include in each audio clip according to user-defined preferences.

17. The method of claim 15 further comprising playing an audio clip when the corresponding audio marker is selected by a user.

18. The method of claim 17 further comprising determining how much of the corresponding audio clip is played according to user-defined preferences.

19. A method for processing a voice audio stream comprising:
processing a voice audio stream looking for a plurality of defined words;
generating text in an output file for portions of the voice audio stream that correspond to any of the plurality of defined words;
creating an audio clip from the voice audio stream for each portion of the voice audio stream that does not correspond to any of the plurality of defined words; and
creating an audio marker that is placed in the output file at a position that identifies the position of each audio clip relative to text in the output file.

20. The method of claim 19 further comprising playing an audio clip when the corresponding audio marker is selected by a user during the display of the output file to the user.

21. A method for reducing the size of digital voice audio information comprising:
processing the digital voice audio information looking for a plurality of defined words; and
replacing at least one portion of the digital audio information with text corresponding to at least one of the plurality of defined words.

22. A method for visually indicating to a user the efficiency of converting digital voice audio information to text, the method comprising:
processing the digital voice audio information looking for a plurality of defined words;
replacing at least one portion of the digital audio information with text corresponding to at least one of the plurality of defined words;
calculating the efficiency from the proportion of replaced digital audio information to total digital audio information; and
displaying the efficiency to the user.

23. A computer-readable program product comprising:
(A) a voice recognition processor that processes a voice audio stream looking for a plurality of defined words, the voice recognition processor generating an output file that includes text corresponding to the plurality of defined words, the output file further including at least one audio marker that is linked to at least one portion of the voice audio stream that does not correspond to the plurality of defined words; and
(B) signal bearing media bearing the voice recognition processor.

24. The computer-readable program product of claim 23 wherein the signal bearing media comprises recordable media.

25. The computer-readable program product of claim 23 wherein the signal bearing media comprises transmission media.

26. The computer-readable program product of claim 23 wherein the voice recognition processor, when a defined word is found in the voice audio stream, replaces in the output file the defined word in the voice audio stream with text corresponding to the defined word.

27. The computer-readable program product of claim 23 wherein the voice recognition processor generates an audio clip for at least one portion of the voice audio stream that contains sounds that do not correlate to any defined word, and wherein each audio marker in the output file is linked to a corresponding audio clip.

28. The computer-readable program product of claim 27 wherein the voice recognition processor determines how much of the voice audio stream is included in each audio clip according to user-defined preferences.

29. The computer-readable program product of claim 27 wherein the voice recognition processor plays an audio clip when the corresponding audio marker is selected by a user.

30. The computer-readable program product of claim 29 wherein the voice recognition processor determines how much of the corresponding audio clip is played according to user-defined preferences.

31. The computer-readable program product of claim 23 wherein the voice recognition processor displays a clarity meter that visually indicates to a user the efficiency of the voice recognition processor in converting the voice audio stream to text.

32. A computer-readable program product comprising:
(A) a voice recognition processor comprising:
a plurality of defined words;
a digital audio processor that processes a voice audio stream looking for the plurality of defined words;
a text generator that generates text in an output file for portions of the voice audio stream that correspond to any of the plurality of defined words; and
a digital audio editor that creates an audio clip from the voice audio stream for each portion of the voice audio stream that does not correspond to any of the plurality of defined words, wherein the digital audio editor creates an audio marker that is placed in the output file at a position that identifies the position of each audio clip relative to text generated by the text generator; and
(B) signal bearing media bearing the voice recognition processor.

33. The computer-readable program product of claim 32 wherein the signal bearing media comprises recordable media.

34. The computer-readable program product of claim 32 wherein the signal bearing media comprises transmission media.

35. The computer-readable program product of claim 32 wherein the voice recognition processor plays an audio clip when the corresponding audio marker is selected by a user during the display of the output file to a user.

36. The computer-readable program product of claim 32 wherein the voice recognition processor displays a clarity meter that visually indicates to a user the efficiency of the voice recognition processor in converting the voice audio stream to text.

37. A computer-readable program product comprising:
(A) a voice recognition processor comprising:
a plurality of defined words;
a digital audio processor that processes digital voice audio information looking for the plurality of defined words;
a digital audio compressor that reduces the size of the digital voice audio information by replacing at least one portion of the digital voice audio information with text corresponding to at least one of the plurality of defined words; and
(B) signal bearing media bearing the voice recognition processor.
